(19) United States
(12) Patent Application Publication
(10) Pub. No.: US 2024/0139841 A1
(43) Pub. Date: May 2, 2024

(54) PIPE PEELER

(71) Applicants: Sascha Oswald, Grimsby (CA); Fritz Oswald, Grimsby (CA)

(72) Inventors: Sascha OSWALD, Grimsby (CA); Fritz Oswald, Grimsby (CA)

(21) Appl. No.: 18/486,243

(22) Filed: Oct. 13, 2023

Related U.S. Application Data
(60) Provisional application No. 63/419,764, filed on Oct. 27, 2022.

(51) Int. Cl. B23D 79/12

(52) U.S. Cl. CPC B23D 79/12

(57) ABSTRACT

There is provided a pipe peeler for removing a layer of material from an outer surface of a pipe. The pipe peeler includes a split housing for releasably mounting around the outer surface of the pipe, and three or more rollers rotatably secured to the housing. Each of the rollers has a contact surface that extends into a central opening for rotational contact with the pipe. Each of the rollers are positioned in the same plane, wherein the plane of the rollers is oriented perpendicular to a longitudinal axis of the split housing The pipe peeler includes a cutting blade, secured to an arm for mounting to the split housing, and a handle extending from the split housing for manually rotating the cutting blade about the outer surface of the pipe. Rotational contact between the rollers and the pipe stabilizes the pipe within the central opening.

### BACKGROUND OF THE INVENTION

### 1. Field of the Invention

The invention relates generally to devices used for preparing pipe end surfaces for welding of sleeves thereon, and more specifically to devices used for shaving a portion of the outer diameter of a pipe in preparation of welding.

### 2. Description of the Related Art

Currently, the most popular way of transmitting natural gas is through the use of plastic pipes which are generally made of polyethylene, polyvinyl chloride or other types of plastic. These pipes are interconnected end to end by welding sleeves onto the end of a pipe, which in turn is welded onto the next length of pipe to be connected. The surfaces of the pipe ends must be prepared to remove any trace of dirt and/or oxidation so that a connecting sleeve can be effectively welded thereto. In order to remove the oxidized layer, currently the end of the pipe is prepared by either scraping manually using a sharp scraper blade and/or sanding using fine grit sand paper. In other instances, abrasive powder is used in order to abrade the end surface, thereby removing the oxidized layer and any dirt thereon. Unfortunately, the effectiveness of these methods and the repeatability of obtaining a good clean oxide free surface prior to welding of a connecting sleeve onto the end of the pipe has been rather poor. The quality of the surface preparation is depended upon how effective the operator is in scraping the surface and/or applying the sand paper or abrasive grit, the length of time that the cleaning has taken place and the skill of the operator in preparing the surface. This leads to quality control issues with regard to the repeatability in preparing a good clean oxide free surface for welding of connecting sleeves onto the ends of plastic pipes.

Other tools on the market are designed to remove the oxidation layer by peeling the pipe. However, such tools cannot peel in close proximity to a shoulder or step on the pipe or a pipe fitting. Existing tools also tend to have difficulty removing a consistent peel thickness on a pipe that is not straight, and commonly have structures that contact the pipe after it has been peeled, potentially introducing contamination.

Those skilled in the art are aware that leaks in natural gas pipe lines cannot be tolerated and can lead to disastrous consequences. It is therefore desirable that an oxide free clean surface be prepared in a consistent and repeatable manner so that a high degree of quality control can be exercised when welding connecting sleeves to the end of pipes.

Another disadvantage of known devices is that they are often unable to accommodate thick portions, defective ovalization, or out-of-roundness of the pipe. Ovalization is a common problem in the field where pipes are typically stored on a coil. After pipe is unwound from a coil its cross-section typically remains somewhat oval (or out-of-round). Pipe unwound from a coil is also typically not straight, having a large radius bend to it. Known devices often do not make it possible to lift off or remove an even shaving or a very small portion of the outer diameter of the pipe, regardless of the pipes' deformations which include ovalization, thickness variations and/or outer deflections. Known devices also commonly do not make it possible to lift off a shaving, or a very small portion, of the outer diameter of the pipe if the pipe has a bend, an uneven curvature, surface defects, is non-circular, or has other changes in surface geometry, such as structural components or variations.

### BRIEF SUMMARY OF THE INVENTION

In one aspect of the invention, there is provided a pipe peeler for removing a layer of material from an outer surface of a pipe or a pipe fitting, the pipe peeler comprising a split housing for releasably mounting around the outer surface of the pipe or pipe fitting, the housing including a central opening with a longitudinal axis; three or more rollers rotatably secured to the housing, each of the rollers having a contact surface that extends into the central opening for rotational contact with the pipe or pipe fitting when the split housing is releasably mounted thereon, each of the rollers being positioned in the same plane, wherein the plane of the rollers is oriented perpendicular to a longitudinal axis of the split housing; a cutting blade secured to an arm, the arm pivotally mounted to the split housing; and a handle extending from the split housing for manually rotating the split housing about the outer surface of the pipe or pipe fitting for shaving the layer of material from the outer surface of the pipe or pipe fitting; wherein contact between the rollers and the outer surface of the pipe or pipe fitting stabilizes the pipe or pipe fitting within the central opening of the split housing as the cutting blade shaves the layer of material.

In an aspect, the cutting blade is positioned in the same plane as the rollers and positioned adjacent and downstream to one of the rollers This helps to maintain a uniform shaving thickness.

In another aspect, there is provided a pipe peeler for removing a uniform layer of material from an outer surface of a pipe or a pipe fitting, the pipe peeler comprising a split housing for releasably mounting around the outer surface of the pipe or pipe fitting, the housing including a central opening with a longitudinal axis, the split housing comprising two housing sections pivotably coupled together by a hinge; a resilient closing mechanism coupled between the two housing sections and configured to resiliently hold the two housing sections in a closed configuration; three or more rollers rotatably secured to the housing, each of the rollers having a contact surface that extends into the central opening for rotational contact with the pipe or pipe fitting when the split housing is mounted thereon, each of the rollers being positioned in the same plane, wherein the plane of the rollers is oriented perpendicular to a longitudinal axis of the split housing; a cutting blade secured to an arm, the arm mounted to the split housing, the cutting blade including a cutting edge; a locking mechanism releasably engagable with the arm for releasably securing the arm in a disengaged positon wherein the cutting blade is prevented from contacting the outer surface of the pipe or pipe fitting; and a handle extending from the split housing for manually rotating the split housing about the outer surface of the pipe or pipe fitting for shaving the layer of material from the outer surface of the pipe or pipe fitting; wherein contact between the rollers and the pipe or pipe fitting stabilizes the pipe or pipe fitting within the central opening of split housing as the cutting blade shaves the uniform layer of material from the outer surface of the pipe or pipe fitting.

### BRIEF DESCRIPTION OF THE DRAWINGS

For a better understanding of the present invention, and to show more clearly how it may be carried into effect, reference will now be made, by way of example, to the accompanying drawings which show exemplary embodiments of the present invention in which:

FIG. 1 is a top, front perspective view of a pipe peeler in a closed configuration according to an example embodiment.

FIG. 2 is a bottom, front perspective view of the pipe peeler of FIG. 1.

FIG. 3 is a front view of the pipe peeler of FIG. 1.

FIG. 4 is an exploded view of the pipe peeler of FIG. 1.

FIG. 5 is an enlarged, cross-sectional view along line 5-5 of FIG. 3.

FIG. 6 is a perspective view of a cutting blade mounted on an arm from the pipe peeler of FIG. 1 in isolation.

FIG. 7 is a side view of the cutting blade and arm of FIG. 6 with internal components shown in dashed lines.

FIG. 8 is a perspective view of the cutting blade of FIG. 6 in isolation.

FIG. 9 is a perspective view of the pipe peeler of FIG. 1 coupled to a pipe.

FIG. 10 is a perspective view of the pipe peeler of FIG. 1 in use with a pipe.

FIG. 11 is a perspective view of the pipe of FIG. 10 in isolation with a shaving partially shaved off.

FIG. 12 is a top, front perspective view of a pipe peeler according to another example embodiment with an arm in an engaged position.

FIG. 13 is a front view of the pipe peeler of FIG. 12.

FIG. 14 is a view of the pipe peeler of FIG. 13 with the arm in a disengaged position.

### DETAILED DESCRIPTION OF THE INVENTION

The present invention may be embodied in a number of different forms. The specification and drawings that follow describe and disclose some of the specific forms of the invention.

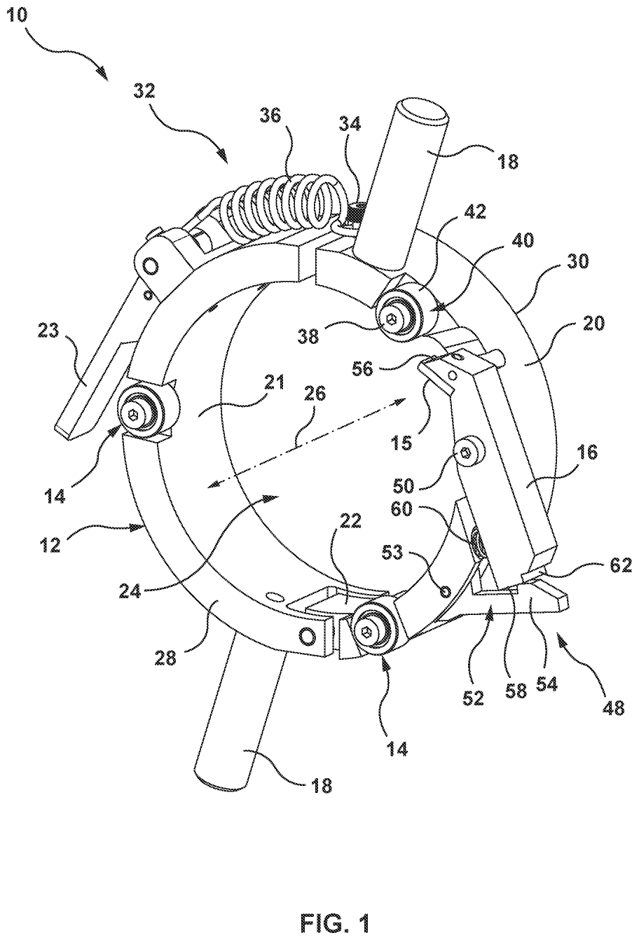

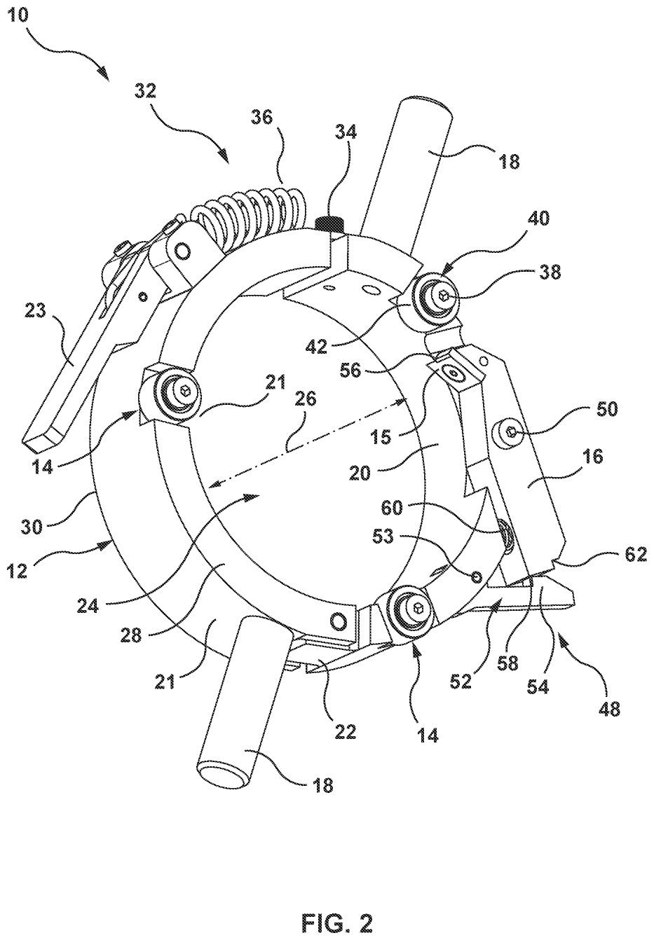

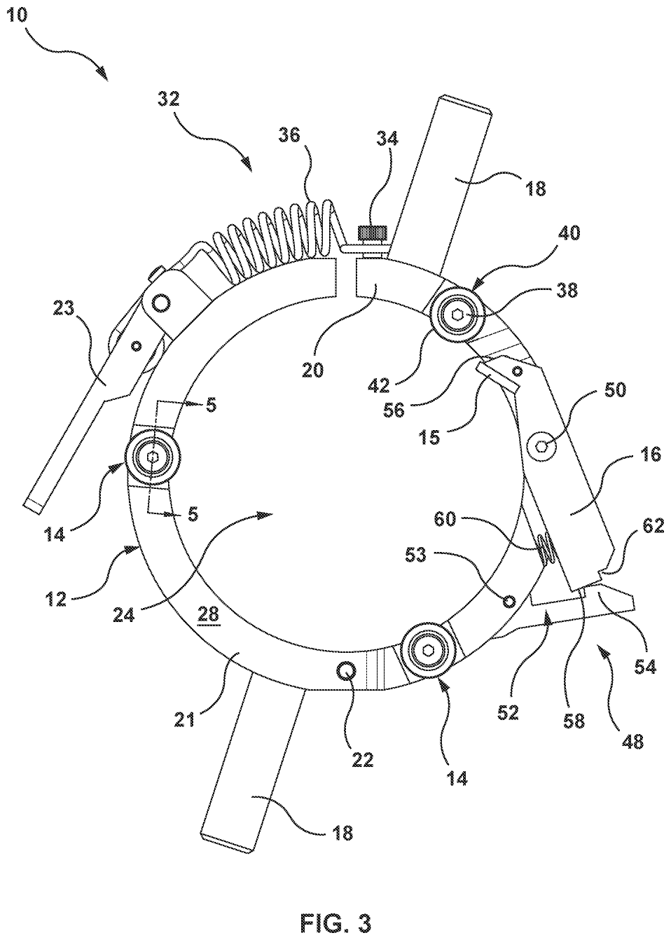

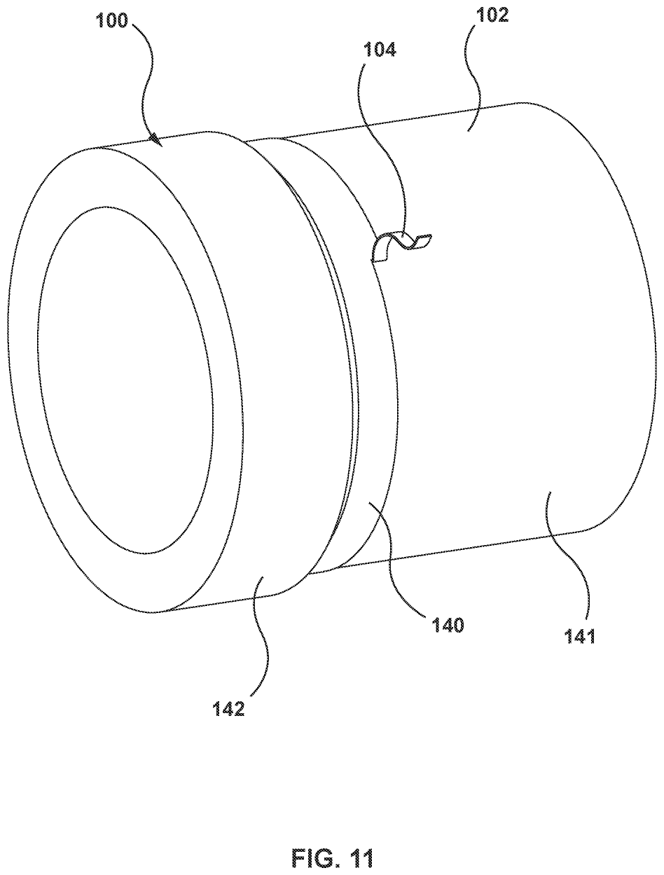

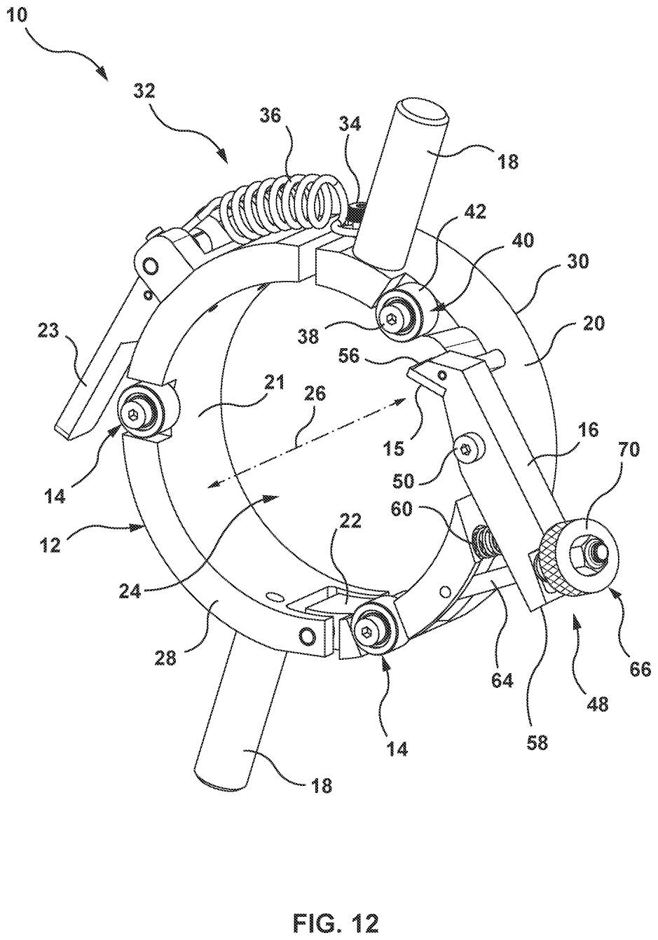

The present invention relates to a pipe peeler, shown generally as 10, for removing a generally uniform layer of material from an outer surface 102 of a pipe 100. FIGS. 1 to 10 show one example embodiment of the pipe peeler 10, while FIGS. 12 to 14 show another example embodiment of the pipe peeler 10. For illustration purposes, in the following description pipe 100 may be a length of pipe or may be a pipe fitting. Pipe (pipe fitting) 100 may comprise an unpeeled portion 140, a peeled portion 141, and an obstruction 142 (see in general FIG. 11). Pipe peeler 10 includes the following major components, a split housing 12, three or more rollers 14 rotatably secured to split housing 12, a cutting blade 15 secured to an arm 16 that is pivotably coupled to split housing 12, and one or more handles 18 extending from split housing 12.

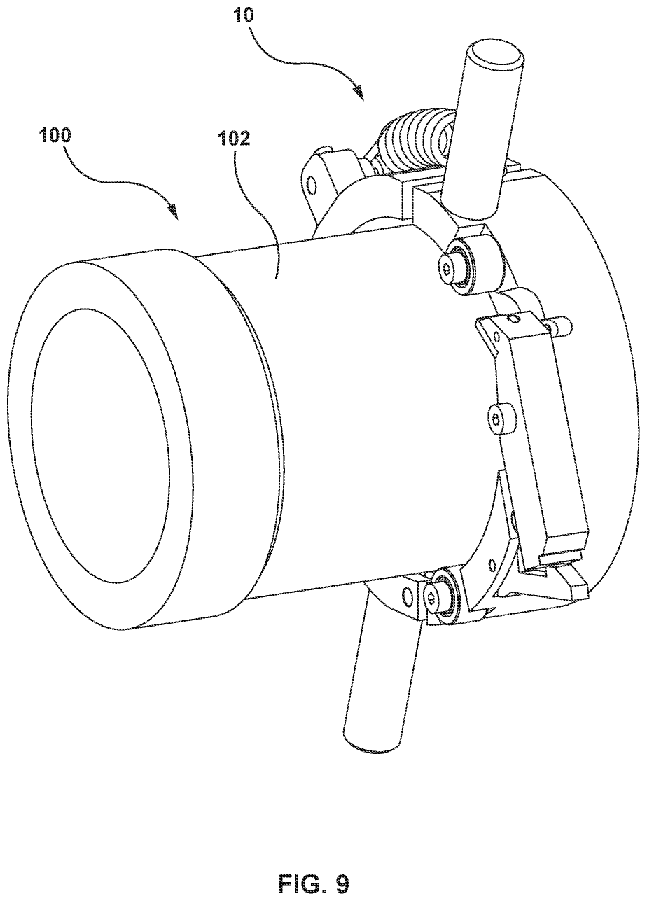

In the embodiment depicted in FIGS. 1-4, split housing 12 is illustrated as having at least two housing sections 20, 21 pivotably coupled together by a hinge 22. Housing sections 20, 21 of split housing 12 collectively define a central opening 24 with a longitudinal axis 26 when in a closed configuration (as shown in FIGS. 1-3). Housing sections 20, 21 are shaped and dimensioned to generally correspond with the shape and dimensions of pipe 100. In this manner, split housing 12 may be releasably mounted around outer surface 102 of pipe 100, with pipe 100 extending through central opening 24 (see FIGS. 7 and 8, for example). Split housing 12 is further shown to have a first end 28 and a second end 30, with housing sections 20, 21 extending therebetween. Other embodiments of split housing 12 may include a larger number of components that may also be releasably secured together.

In the depicted embodiment split housing 12 is shown as having a resilient closing mechanism 32 coupling and securing the two housing sections 20, 21 together. In FIGS. 1-3, resilient closing mechanism 32 is in a locked state and is configured to resiliently hold housing sections 20, 21 in their closed configuration.

Resilient closing mechanism 32 may include a hook 34 secured to one of the housing sections. For example, hook 34 may be secured to housing section 20 positioned opposite hinge 22. Resilient closing mechanism 32 may include a spring 36, where one end of spring 36 is secured to the other one of the components, such as housing section 21, the other end of spring 36 is configured to be releasably securable to hook 34 for operational engagement therewith. Spring 36 is shown secured to housing section 21 and is also positioned generally opposite to hinge 22. The depicted embodiment of resilient closing mechanism 32 optionally includes a latch 23 coupled to, and between, the one end of spring 36 and housing section 21. In the depicted embodiment of FIGS. 1-3, latch 23 is secured to the one end of spring 36 and is pivotably coupled to housing section 21. In this manner, pivoting latch 23 towards spring 36 brings resilient closing mechanism 32 into an unlocked state, while pivoting latch 23 away from spring 36 brings resilient closing mechanism 32 into the locked state shown.

In other applications, resilient closing mechanism 32 may take other forms known in the art and/or include other biasing members or other types of closure mechanisms, such as an elastic member, a spring clip, etc.

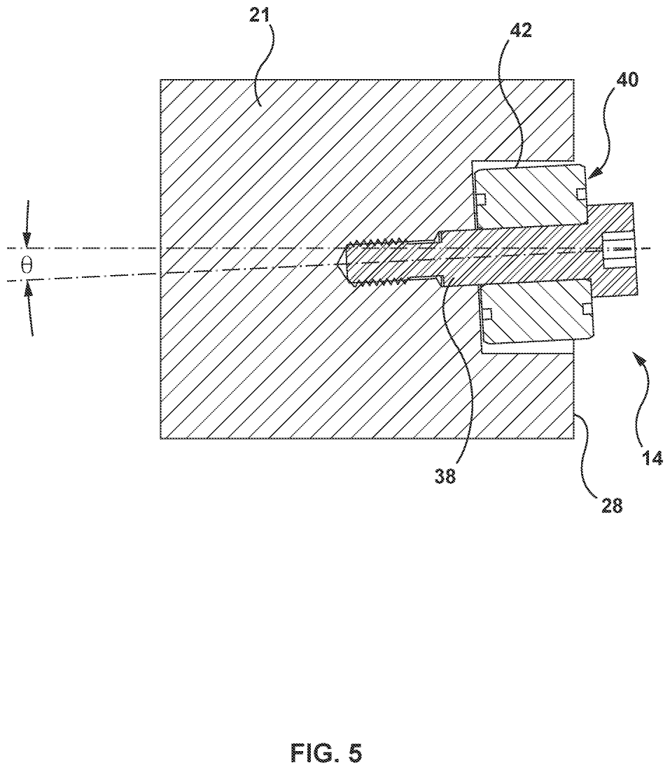

Rollers 14 are rotatably secured to split housing 12. As best seen in FIG. 5, rollers 14 each comprise an axle 38 and a wheel 40 secured thereto. Each wheel 40 has an outer contact surface 42. In the depicted embodiment, each roller 14 is rotatably secured at one end, such as first end 28, to split housing 12, with axle 38 of each roller 14 orientated at a slight angle to longitudinal axis 26 (see 0 in FIG. 5). The slight angle of each roller 14 relative to axis 26 permits the roller to generally move through a helical path as it (and pipe peeler 10) is rotated about the surface of pipe 102. In the embodiment shown, axles 38 are partially threaded bolts, with each wheel 40 positioned around the unthreaded portion of the bolt. Wheels 40 may be recessed into first end 28 of split housing 12 with contact surface 42 of each roller 14 extending into central opening 24 for rotational contact with pipe 100. In accordance with the invention, each of the rollers 14 is positioned in generally the same plane, with the plane being oriented approximately 90 degrees to the longitudinal axis of split housing 12 and to pipe 100 (during operation). Rollers 14 (that are positioned on the same plane) may be considered a single group of rollers (in contrast to multiple parallel groups), which helps ensure split housing 12 is always aligned with the curvature of pipe 100. Such a structure is particularly advantageous when peeling the surface of a length of pipe that is not straight and that may be curved.

Further, rollers 14 are also generally aligned with cutting blade 15 such that the rollers and the cutting blade are positioned in the same general plane that is oriented approximately 90 degrees to the longitudinal axis of the split housing and to that of pipe 100 (during operation). In this manner, cutting blade 15 will effectively “follow” the rollers as pipe peeler 10 is rotated about the exterior surface of pipe 100.

In an embodiment, rollers 14 may be of a significant width to enhance their surface contact with the outer surface of pipe 100. It will be appreciated that increasing the width of the rollers, above and beyond the width of the rollers of currently used pipe peelers, in conjunction with locating cutting blade 15 in the same general plane as the rollers will enhance the ability of pipe peeler 10 to accommodate variations in the geometry of the pipe while also permitting the removal or shaving of a relatively consistent thickness from the pipe's surface.

In the depicted embodiment, pipe peeler 10 is shown as having three rollers 14 positioned about first end 28, where each of the rollers 14 are positioned on a common plane that is generally perpendicular to the longitudinal axis of the pipe peeler 10. Alternatively, pipe peeler 10 may have more than three rollers 14, with each of the rollers positioned on the common plane. The axles of the rollers are generally orientated at a small angle to longitudinal axis 26, as described above, and each contact surface 42 preferably extends into central opening 24, or is positioned so as to helically rotate along the surface of pipe 100.

The contact of rollers 14 with pipe 100 helps to stabilize pipe 100 within pipe peeler 10 as cutting blade 15 shaves a layer of material off outer surface 102 of pipe 100. As discussed above, with rollers 14 positioned about first end 28 in a common plane pipe peeler 10 is able to accommodate pipes 100 that may have a bend, an uneven curvature, that may have surface defects, that may be “out-of-round” or non-circular, or that may have other variations in surface geometry along outer surface 102. The elastic resilience of resilient closing mechanism 32, in use in combination with rollers 14, further allows rollers 14 to accommodate a wide variety and/or variations in outer surface 102 of pipes 100.

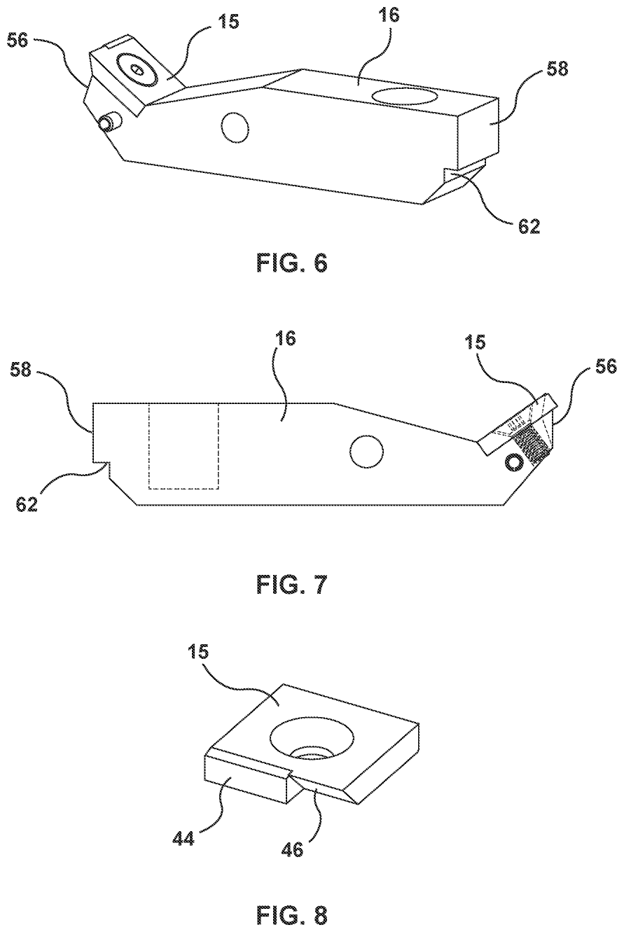

Cutting blade 15 is secured to arm 16, which is used for mounting cutting blade 15 to split housing 12. As best seen in FIGS. 6 and 7, cutting blade 15 may be secured to one end (a distal end) 56 of arm 16. In the depicted embodiment, cutting blade 15 is secured to distal end 56 of arm 16 via a recessed bolt or screw. In an alternate embodiment, cutting blade 15 may be secured to another part of arm 16. Cutting blade 15 may include a blade guide portion 44 (with a chamfered leading surface) and an adjacent cutting edge 46 (see FIG. 8). It will be appreciated from a thorough understanding of the described structure and the discussion that follows that the geometry of blade guide portion 44, and in particular its chamfered leading edge, can be designed to cause cutting edge 46 to evenly “peel” a desired thickness from the surface of a pipe. It will also be appreciated that different cutting blades 15 could be used for different applications, and that such blades could have different geometries to permit different thickness of “peel” to be generated in use.

In an embodiment, arm 16 may be positioned and mounted to split housing 12 such that cutting blade 15 is positioned immediately adjacent (or as close as possible) to, and behind or downstream from, one of the rollers 14. In such a manner, the adjacent roller 14 will only roll on uncut pipe and will not contact the pipe surface after it has been peeled, which could potentially introduce contaminants onto the peeled surface. As the adjacent roller 14 comes into contact with a surface variation on pipe 100, the presence of rollers 14 (all positioned on one plane that is generally perpendicular to the longitudinal axis of the pipe peeler 10) helps split housing 12 maintain firm contact with the pipe 100 despite surface variations, and to hold the pipe peeler 10 steady during operation. The adjacent roller's proximity to blade 15 helps to minimize the angle through which arm 16 has to swing during operation. As cutting blade 15 is positioned close to the adjacent roller 14, the resulting arrangement allows cutting edge 46 of cutting blade 15 to peel or scrape very close to an obstruction or surface variation on pipe 100.

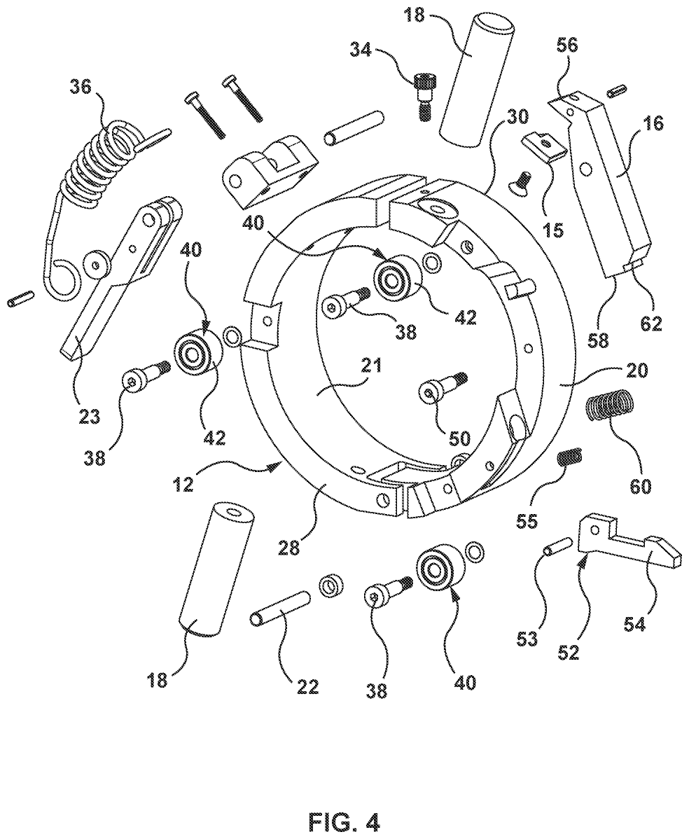

Arm 16 may be pivotably coupled to split housing 12, such as via a pivot 50. Pipe peeler 10 may further include a locking mechanism 48 (releasably) securable to arm 16 for fixing the relative position of cutting edge 46 of cutting blade 15 relative to outer surface 102 of pipe 100. In the embodiment depicted in FIGS. 1 to 10, locking mechanism 48 may include a locking lever 52 secured to split housing 12 and that operatively engages an outer end 58 of arm 16. In the embodiment of FIGS. 1 to 10, locking lever 52 is pivotably coupled to housing section 21 of split housing 12 via a lever pivot 53. Locking lever 52 may further have an arm stop 54 comprising a protrusion or lip extending from the locking lever in a direction toward outer end 58 of arm 16. A lever spring 55 (see FIG. 4) may be positioned between housing section 21 and locking lever 52 in order to bias arm stop 54 towards outer end 58 of arm 16 when in use. In this manner, arm stop 54 may come into contact with outer end 58 of arm 16 to limit or stop the pivoting of arm 16 away from housing section 21.

An arm biasing member 60 may be positioned between housing section 21 and arm 16. Arm biasing member 60 may be positioned proximate outer end 58 of arm 16 in order to bias outer end 58 of arm 16 away from split housing 12, which in turn will pivot cutting blade 15 towards outer surface 102 of pipe 100 during use. Biasing member 60 will have a tendency to apply a relatively constant pressure upon arm 58 and to, thereby, help to maintain a consistent or constant pressure of blade guide 44 against the surface of the pipe, thereby allowing cutting edge 46 to shave a uniform layer of material off outer surface 102 of pipe 100. As noted above, this may be achieved as cutting edge 46 follows blade guide 44 at a fixed offset. In the depicted embodiment, arm biasing member 60 is a coil spring. Alternatively, arm biasing member 60 may be a flexibility resilient metal strip or other flexibility resilient component.

Pivoting outer end 58 of arm 16 towards split housing 12 (i.e. by applying force to the outer surface of the arm and overcoming the biasing force of member 60) moves cutting blade 15 (positioned at the other distal end 56 of arm 16) away from pipe 100 (into a disengaged position) when shaving or cutting is not required. Outer end 58 may further include an indentation or notch 62 that can then be engaged by the protrusion or lip on locking lever 52 to hold or “lock” arm 16 in place, in the disengaged positon with cutting blade 15 displaced from contact with pipe 100. Grasping the outer end of locking lever 52 to displace its protrusion or lip from engaging notch 62 allows biasing member 60 to rotate arm 16 into an engaged positon (not shown), where cutting blade 15 again engages outer surface 102 of pipe 100.

Pipe peeler 10 further includes at least one handle 18 that extends from split housing 12. Handle 18 is configured for manually rotating split housing 12 about pipe 100. The depicted embodiment includes two handles 18, one extending from each of housing sections 20, 21 of split housing 12, offset by approximately 180 degrees from one another. Other numbers and positons of handles are contemplated. Handles 18 are shown to be positioned generally in-line with one or more rollers 14, and notably, in-line with cutting edge 46 of cutting blade 15. That is, handles 18 may be arranged and orientated on generally the same plane (that is generally perpendicular to the longitudinal axis of split housing 12) as the one or more rollers 14, and particularly on the same plane as cutting edge 46 of cutting blade 15. In use, the user applies a tangential force to handles 18 to overcome the resistance of cutting blade 15 in order to rotate pipe peeler 10 about surface 102 of pipe 100 and to shear pipe 100. Alignment of handles 18 with cutting edge 46 of cutting blade 15 will tend to help to minimize or eliminate a twisting or torqueing of split housing 12 in a direction other than perpendicular to outer surface 102 of pipe 100.

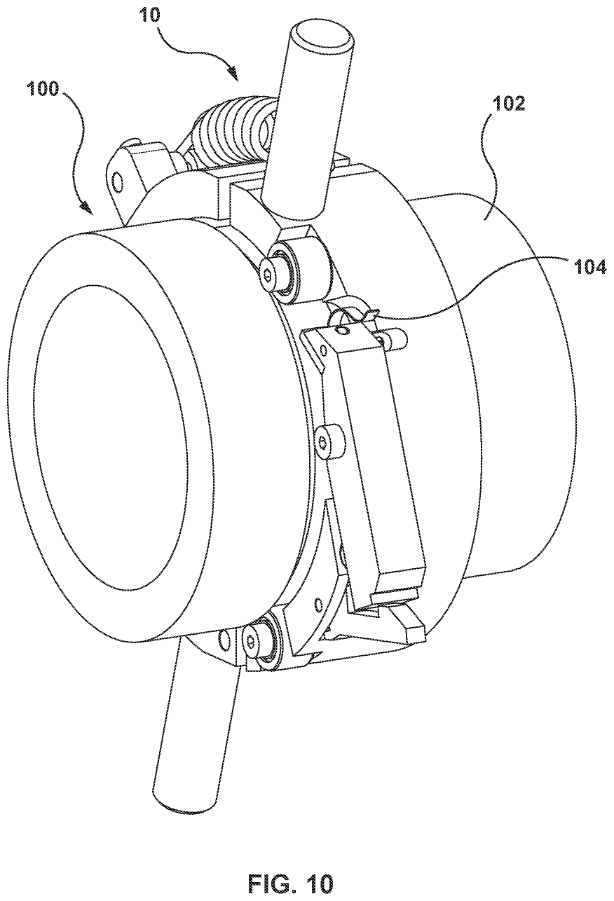

Referring specifically to FIGS. 9 through 11, pipe peeler 10 may be used in circumstances where one wishes to shave off a thin layer from outer surface 102 of a pipe 100 to provide a clean, oxide free, surface for subsequent welding operations and for attaching various components to the pipe. In some cases, pipe 100 may be bent or curved, or may have an uneven curvature, surface defect, may be non-circular, or have other variations or obstructions in surface geometry at outer surface 102. Historically, such variations can make shaving off a thin layer of uniform thickness difficult. The present pipe peeler 10, with rollers 14 all positioned on a common plane, helps align pipe peeler 10 with the curvature of pipe 100 and helps allow pipe peeler 10 to peel a thin layer of uniform thickness close to an obstruction, such as a step or shoulder in pipe 100. It will also be appreciated that the described structure of pipe peeler 10 will permit it to be readily used on the spigot end of a pipe fitting. In that regard, the structure of pipe peeler 10 will permit a “peeling” of the surface of the spigot essentially all of the way along its length and right up to a shoulder of the fitting body. Existing devices do not allow a full peeling of the spigot along its entire length.

In order to begin the pipe shaving or peeling process, split housing 12 is “opened” through bringing resilient closing mechanism 32 into the unlocked state by disengaging spring 36 from hook 34. Housing sections 20, 21 can then pivotally open about hinge 22 and be placed around an exterior portion of an end or middle portion of pipe 100, or for that matter about a spigot of a pipe fitting (such as a tee, elbow, etc). Such fittings often have an enlarged outer diameter to compensate for the decreased strength of pipe 100 in the area of the tee, the elbow bend, or aspect of the fitting. Such an increase in the outer diameter of a fitting may itself be an obstruction which current tools cannot get close to, due to the typical layout of two sets of rollers lying along the longitudinal plane of the pipe or the spigot of a fitting.

Once split housing 12 is placed around outer surface 102 of pipe 100, housing sections 20, 21 may brought together, spring 36 may be re-engaged with hook 34, and latch 23 may be pivoted towards split housing 12 to bring resilient closing mechanism 32 into its locked state.

It should be noted that the above described arrangement is by way of example and that other techniques known in mechanical arts could be used to releasably clamp housing sections 20, 21 around a pipe 100.

With split housing 12 clamped about the exterior of the pipe, cutting blade 15 can be brought into contact with outer surface 102 of pipe 100. If arm stop 54 of locking lever 52 is engaged with notch 62 and holding cutting blade 15 away from pipe 100, locking lever 52 may be pivoted to disengage arm stop 54 from notch 62. At that point, biasing member 60 will push outer end 58 of arm 16 away from split housing 12, thereby pivoting cutting blade 15 (secured to the other end 56 of arm 16) towards outer surface 102 of pipe 100 until the leading portion of cutting edge 46 contacts the pipe surface.

In order to effect a shaving or peeling of outer surface 102 of pipe 100, a user grasps handles 18 and rotates split housing 12 about the outer diameter of the pile. As the split housing is rotated, blade guide 44 “reads” or “follows” the surface 102 of pipe 100. In turn, the leading portion of cutting edge 46, which is at a fixed offset from blade guide 44, is now resiliently biased against outer surface 102 of pipe 100 by biasing member 60, and bites or cuts into the outer surface 102 of pipe 100, forming a generally continuous shaving 104 that is removed from outer surface 102 of pipe 100. As cutting edge 46 is continuously moving along surface 102, each rotation of split housing 12 results in shaving 104 being taken off outer surface 102 of pipe 100 (see FIGS. 9-11). Once a desired area of outer surface 102 has been removed, handles 18 are no longer rotated and cutting blade 15 may be retracted from outer surface 102. In the embodiment shown in FIGS. 1 to 10, this may be achieved by pivoting outer end 58 of arm 16 towards split housing 12 (against the force of biasing member 60), and engaging arm stop 54 with notch 62 to lock cutting blade 15 in place, away from pipe 100. Pipe peeler 10 may be removed from pipe 10 by unlocking resilient closing mechanism 32 and opening split housing 12 as described above.

FIGS. 12 to 14 illustrate another embodiment of pipe peeler 10 that is largely similar to the embodiment shown in FIGS. 1 to 10, with the exception of locking mechanism 48. In FIGS. 12 to 14, rather than locking lever 52, locking mechanism 48 includes a locking screw 64, that is secured to, and extends from, split housing 12, and a locking knob or nut 66 operatively engaged with locking screw 64 and the outer end 58 of arm 16. In the embodiment of FIGS. 12 to 14, locking screw 64 is secured to housing section 21 of split housing 12, and extends through an opening in the outer end 58 of arm 16. Locking nut 66 comprises a body 68 adapted to contact the outer end 58 of arm 16, with body 68 further having internal threads that are dimensioned to operatively receive locking screw 64 therethrough. Locking nut 66 is shown further comprising a head 70 that is sized and configured to be grasped and rotated by a user in order to rotate and slide locking nut 66 along locking screw 64.

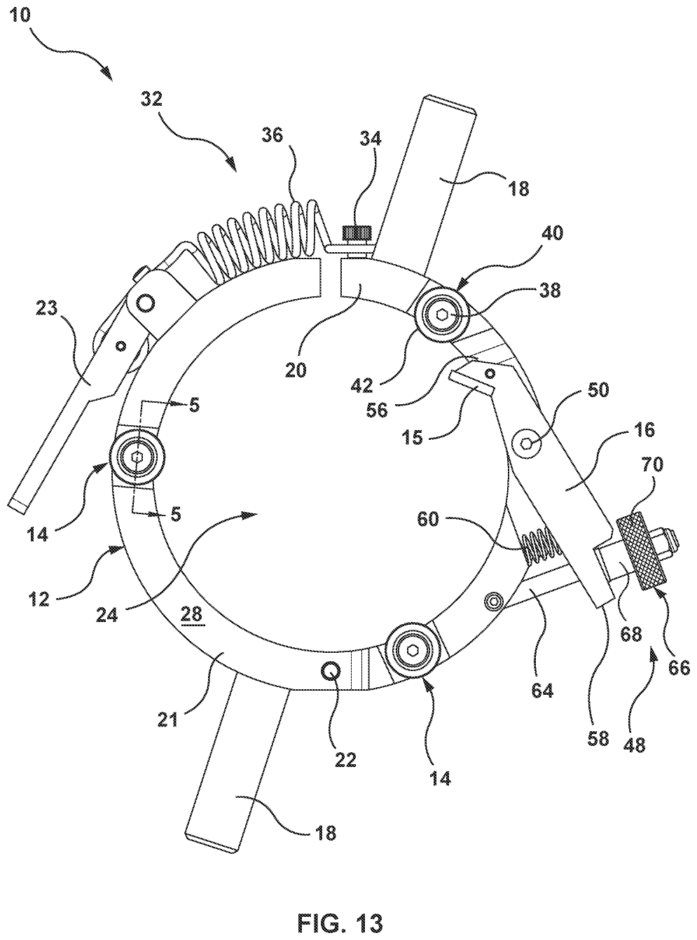

The embodiment depicted in FIGS. 12 to 14 also includes arm biasing member 60 positioned between housing section 21 and arm 16. Arm biasing member 60 may be positioned proximate outer end 58 of arm 16 in order to bias outer end 58 of arm 16 away from split housing 12. When locking nut 66 is positioned at or near an outer end of locking screw 64, this allows outer end 58 of arm 16 to be biased by arm biasing member 60 away from split housing 12, which pivots cutting blade 15 towards outer surface 102 of pipe 100 during use (see FIG. 13). As noted above, biasing member 60 has the tendency to apply a relatively constant pressure upon arm 58 and to, thereby, help to maintain a consistent or constant pressure of blade guide 44 against the surface of the pipe, thereby allowing cutting edge 46 to shave a uniform layer of material off outer surface 102 of pipe 100. In the depicted embodiment, arm biasing member 60 is a coil spring. Alternatively, arm biasing member 60 may be a flexibility resilient metal strip or other flexibility resilient component.

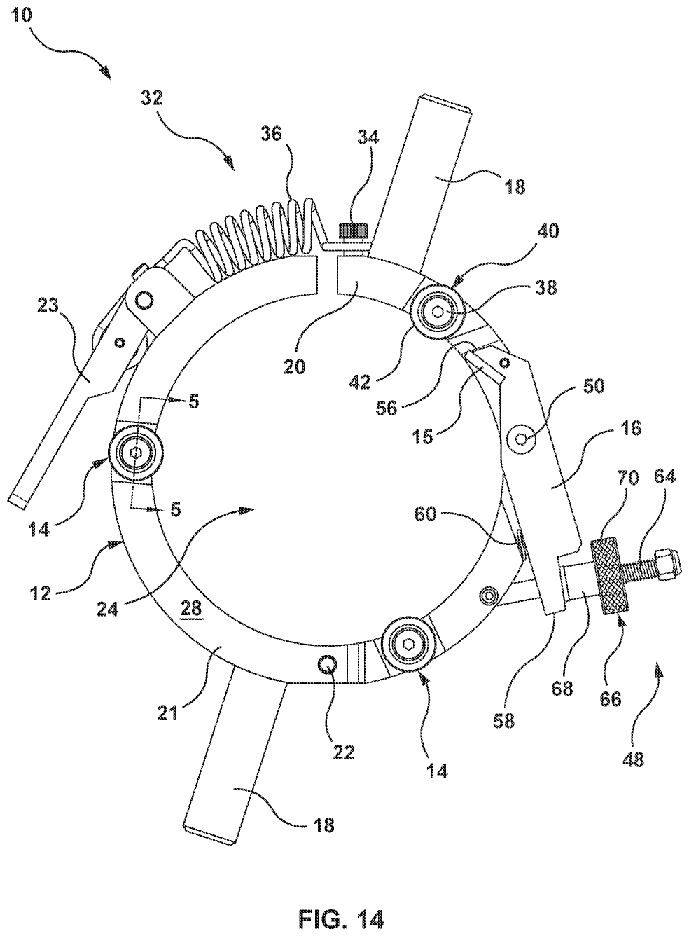

When locking nut 66 is rotated/turned so as to slide locking nut 66 down along locking screw 64, this pivots outer end 58 of arm 16 towards split housing 12 and moves cutting blade 15 (positioned at the other end 56 of arm 16) away from pipe 100 into the disengaged position (see FIG. 14). In a similar manner, when locking nut 66 is rotated/turned so as to slide locking nut 66 up along locking screw 64, this pivots outer end 58 of arm 16 away from split housing 12 and moves cutting blade towards pipe 100 into the engaged position. Locking screw 64 and locking nut 66 may be dimensioned to correspond such that the frictional engagement between the internal threads of locking nut 66 and the external threads of locking screw 64 are sufficient to hold locking screw 64 and locking nut 66 in the engaged or disengaged position relative to one another.

It should be noted that the above described arrangements are by way of example, and that other techniques known in the mechanical arts could be used to move (and hold) arm 16 between (and in) the engaged and disengaged positions.

As noted above, pipe peeler 10 is advantageously able to help remove material from outer surface 102 of pipe 100, even when pipe 100 has a bend, an uneven curvature, surface defects, is non-circular, or has other variations in surface geometry on outer surface 102. The presence of rollers 14, and their location in generally the same plane as cutting blade 15 (as described above), allows the rollers to help to stabilize pipe 100 within pipe peeler 10 and to present the surface to the pipe to cutting blade 15 in a manner that helps to accommodate variations in the diameter or “roundness” of, or obstructions on, the pipe. Further, the elastic resilience of closing mechanism 32, in combination with rollers 14, also tends to help rollers 14 to accommodate different variations in the geometry of outer surface 102 of pipe 100. As described, the present pipe peeler 10, with rollers 14 positioned on a common plane, also helps allow pipe peeler 10 to peel a thin layer of uniform thickness close to an obstruction, such as a step or a shoulder in pipe 100.

It should be apparent to persons skilled in the art that various modifications and adaptation of this structure described above are possible without departure from the spirit of the invention the scope of which defined in the appended claim. For example, while use of the described pipe peeler for removing a portion of the exterior surface of the end of a pipe has been described, it will be appreciated that the described device may also be used to remove a portion of the exterior surface of a spigot on a pipe fitting or other such structure, as well as the middle of the pipe where there is no access to the pipe's ends.

It is to be understood that what has been described are the preferred embodiments of the invention. The scope of the claims should not be limited by the preferred embodiments set forth above, but should be given the broadest interpretation consistent with the description as a whole.

What is claimed is:

1. A pipe peeler for removing a layer of material from an outer surface of a pipe or a pipe fitting, the pipe peeler comprising;
(a) a split housing for releasably mounting around the outer surface of the pipe or pipe fitting, the housing including a central opening with a longitudinal axis;
(b) three or more rollers rotatably secured to the housing, each of the rollers having a contact surface that extends into the central opening for rotational contact with the pipe or pipe fitting when the split housing is releasably mounted thereon, each of the rollers being positioned in the same plane, wherein the plane of the rollers is oriented perpendicular to a longitudinal axis of the split housing;
(c) a cutting blade secured to an arm, the arm pivotally mounted to the split housing; and
(d) a handle extending from the split housing for manually rotating the split housing about the outer surface of the pipe or pipe fitting for shaving the layer of material from the outer surface of the pipe or pipe fitting;
wherein contact between the rollers and the outer surface of the pipe or pipe fitting stabilizes the pipe or pipe fitting within the central opening of the split housing as the cutting blade shaves the layer of material.

2. The pipe peeler of claim 1, wherein the split housing comprises two housing sections pivotably connected at a hinge, the pipe peeler further comprising:
a resilient closing mechanism coupled between the two housing sections and configured to resiliently hold the two housing sections in a closed configuration.

3. The pipe peeler of claim 2, wherein the resilient closing mechanism comprises:
a hook secured to one of the two housing sections; and
a spring having a first end secured to the other of the two housing sections, the spring having a second end configured to be releasably secured to the hook.

4. The pipe peeler of claim 1, wherein the cutting blade is positioned in the same plane as the rollers and adjacent to at least one of the rollers.

5. The pipe peeler of claim 4, wherein the rollers are each mounted to an end of the split housing.

6. The pipe peeler of claim 1, wherein each of the rollers comprises an axle and a wheel, the axle of each roller orientated at an angle to the longitudinal axis of the split housing.

7. The pipe peeler of claim 5, wherein the cutting blade is secured to one end of the arm.

8. The pipe peeler of claim 7, further comprising a locking mechanism engagable with the arm for releasably securing the arm in a disengaged positon wherein the cutting blade is prevented from contacting the outer surface of the pipe or pipe fitting.

9. The pipe peeler of claim 8, further comprising a biasing member operatively associated with the split housing and the arm, the biasing member configured to bias the arm in a manner that presents the cutting blade to the outer surface of the pipe or pipe fitting.

10. The pipe peeler of claim 9, wherein the locking mechanism comprises a locking lever secured to the split housing, the locking lever having an arm stop extending therefrom and releasably engagable with an end of the arm opposite the cutting blade, wherein the arm stop when engaged with the arm limits pivotal movement of the arm.

11. The pipe peeler of claim 10, further comprising a lever spring operatively coupled between the split housing and the locking lever, the lever spring configured to bias the arm stop of the locking lever towards the end of the arm opposite the cutting blade.

12. The pipe peeler of claim 11, wherein the end of the arm opposite the cutting blade comprises a notch, the notch configured to releasably engage the arm stop.

13. The pipe peeler of claim 9, wherein the locking mechanism comprises:
a locking screw secured to and extending from the split housing; and
a locking nut operatively coupled between the locking screw and an end of the arm opposite the cutting blade;
wherein sliding the locking nut away from the split housing pivots the cutting blade towards the outer surface of the pipe or pipe fitting into an engaged position, and sliding the locking nut towards the split housing pivots the cutting blade away from the outer surface of the pipe or pipe fitting into a disengaged position.

14. The pipe peeler of claim 13, wherein the locking nut comprises a body with internal threads and a head secured to the body, the head dimensioned to be grasped and rotated by a user.

15. The pipe peeler of claim 13, wherein the end of the arm opposite the cutting blade comprises an opening through which the locking screw extends.

16. The pipe peeler of claim 1, wherein the handle is positioned co-planer with a cutting edge of the cutting blade.

17. A pipe peeler for removing a layer of material from an outer surface of a pipe or a pipe fitting, the pipe peeler comprising;
(a) a split housing for releasably mounting around the outer surface of the pipe or pipe fitting, the housing including a central opening with a longitudinal axis, the split housing comprising two housing sections pivotably coupled together by a hinge;
(b) a resilient closing mechanism coupled between the two housing sections and configured to resiliently hold the two housing sections in a closed configuration;
(c) three or more rollers rotatably secured to the housing, each of the rollers having a contact surface that extends into the central opening for rotational contact with the pipe or pipe fitting when the split housing is mounted thereon, each of the rollers being positioned in the same plane, wherein the plane of the rollers is oriented perpendicular to a longitudinal axis of the split housing;
(d) a cutting blade secured to an arm, the arm mounted to the split housing, the cutting blade including a cutting edge;
(e) a locking mechanism releasably engagable with the arm for releasably securing the arm in a disengaged positon wherein the cutting blade is prevented from contacting the outer surface of the pipe or pipe fitting; and
(f) a handle extending from the split housing for manually rotating the split housing about the outer surface of the pipe or pipe fitting for shaving the layer of material from the outer surface of the pipe or pipe fitting;
wherein contact between the rollers and the pipe or pipe fitting stabilizes the pipe or pipe fitting within the central opening of split housing as the cutting blade shaves the uniform layer of material from the outer surface of the pipe or pipe fitting.

18. The pipe peeler of claim 17, wherein the cutting edge of the cutting blade is positioned in the same plane as the handle and adjacent to at least one of the rollers.
